(19) United States
(12) Patent Application Publication
(10) Pub. No.: US 2017/0015138 A1
(43) Pub. Date: Jan. 19, 2017

(54) PLURAL SOCKET LUG NUT REMOVAL TOOL

(71) Applicants: Duarte Pamplona, Buda, TX (US); Bradley David Morrow, Clarksville, TN (US)

(72) Inventors: Duarte Pamplona, Buda, TX (US); Bradley David Morrow, Clarksville, TN (US)

(21) Appl. No.: 14/803,080

(22) Filed: Jul. 19, 2015

(51) Int. Cl. B60B 29/00; B25B 13/46

(52) U.S. Cl. CPC B60B 29/005; B25B 13/467

(57) ABSTRACT

A lug nut removal tool for applying rotational force on all lug nuts is shown having a circular frame member, a drive lug, a drive gear, and a plurality of transfer assemblies that each include an adjustable sockets. In one embodiment, rotation of the drive lug actuates the drive gear, thereby causing the each discrete transfer assembly to rotate. The transfer assemblies each include an adjustable socket for engaging a corresponding lug nut on a target wheel. In operation, each socket is first aligned with a corresponding lug nuts on a target vehicle wheel, locked in place, and then turned through the rotational force applied to the drive lug that is transferred to the its integrated transfer assembly by way of the drive gear.

### BACKGROUND OF THE INVENTION

Field of the Invention

This invention relates generally to mechanical tools and, more particularly, to a plural socket lug nut removal tool that removes all nuts simultaneously.

Description of the Prior Art

The use of lug nuts as fasteners for securing a wheel on a vehicle are well known. Vehicles commonly utilize a plurality of lug nuts, between four and six, on each wheel to secure the wheel. Conventionally, lug nuts are installed and removed using a lug wrench or other type of socket wrench, which is used to tighten or loosen each lug nut to a threaded wheel stud. A problem which still exists, however, is that when installing or removing lug nuts, a user is usually forced to tighten or loosen one lug nut at a time. Thus, there remains a need for a tool which enables all of the lug nuts on a wheel to be tighten or loosened simultaneously. It would be helpful if such a lug nut removal tool utilized a gear system to transfer user motion from one location to a plurality of separate locations. It would be additionally desirable for such a lug nut removal tool employed a series of discrete, adjustable sockets to enable it to separately engage each lug nut.

The Applicant's invention described herein provides for a lug nut removal tool adapted to simultaneously engage and rotate each lug nut on a wheel. The primary components in Applicant's lug nut removal tool are a frame member, a drive sprocket, a plurality of transfer assemblies, and a plurality of sockets. When in operation, the lug nut removal tool enables a user to tighten or loosen each of the lug nuts on a wheel by applying rotational force to a single input gear. As a result, many of the limitations imposed by prior art structures are removed.

### SUMMARY OF THE INVENTION

A lug nut removal tool for applying rotational force on all lug nuts is shown having a circular frame member, a drive lug, a drive sprocket, and a plurality of transfer assemblies that each include an adjustable socket members. In one embodiment, rotation of the drive lug actuates the drive sprocket, thereby causing a chain to rotate through each discrete transfer. The transfer assemblies each include an adjustable socket for engaging a corresponding lug nut on a target wheel. In operation, each socket is first aligned with a corresponding lug nuts on a target vehicle wheel, locked in place, and then turned through the rotational force applied to the drive lug that is transferred to its integrated transfer assembly by way of the drive sprocket.

Accordingly, the drive lug provides a receiving means for receiving the application of rotational force, while the drive sprocket and the at least one transfer assembly combine to provide a transfer means for transferring applied rotational force, and the sockets provide an application means for applying transferred force

It is an object of this invention to provide a lug nut removal tool which enables all of the lug nuts on a wheel to be tighten or loosened simultaneously.

It is another object of this invention to provide a lug nut removal tool which utilizes a gear system to transfer user motion from one location to a plurality of separate, selectable locations.

It is yet another object of this invention to provide a lug nut removal tool that employs a series of discrete, adjustable sockets to enable it to separately engage each lug nut.

These and other objects will be apparent to one of skill in the art.

### BRIEF DESCRIPTION OF THE DRAWINGS

FIG. 1 is a top plan view of a lug nut removal tool built in accordance with an embodiment of the present invention.

FIG. 2 is a front side elevational view of a lug nut removal tool built in accordance with an embodiment of the present invention.

FIG. 3 is a rear side elevational view of a lug nut removal tool built in accordance with an embodiment of the present invention in a four lug nut configuration.

FIG. 4 is a rear side elevational view of a lug nut removal tool built in accordance with an embodiment of the present invention in a five lug nut configuration.

FIG. 5A is an elevational view of a cross section of a socket member of a lug nut removal tool built in accordance with an embodiment of the present invention in a locked position.

FIG. 5B is a partial elevational view of a cross section of a socket member of a lug nut removal tool built in accordance with an embodiment of the present invention in an unlocked position.

FIG. 6 is an elevational view of a cross section of a lug nut removal tool built in accordance with an alternate embodiment of the present invention.

FIG. 7 is an elevational view of a cross section of a lug nut removal tool built in accordance with another alternate embodiment of the present invention.

### DETAILED DESCRIPTION OF THE INVENTION

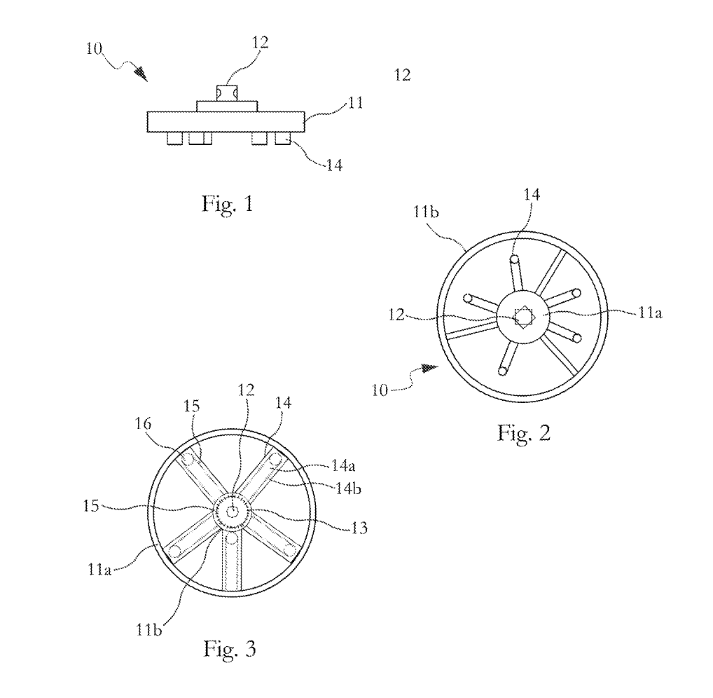

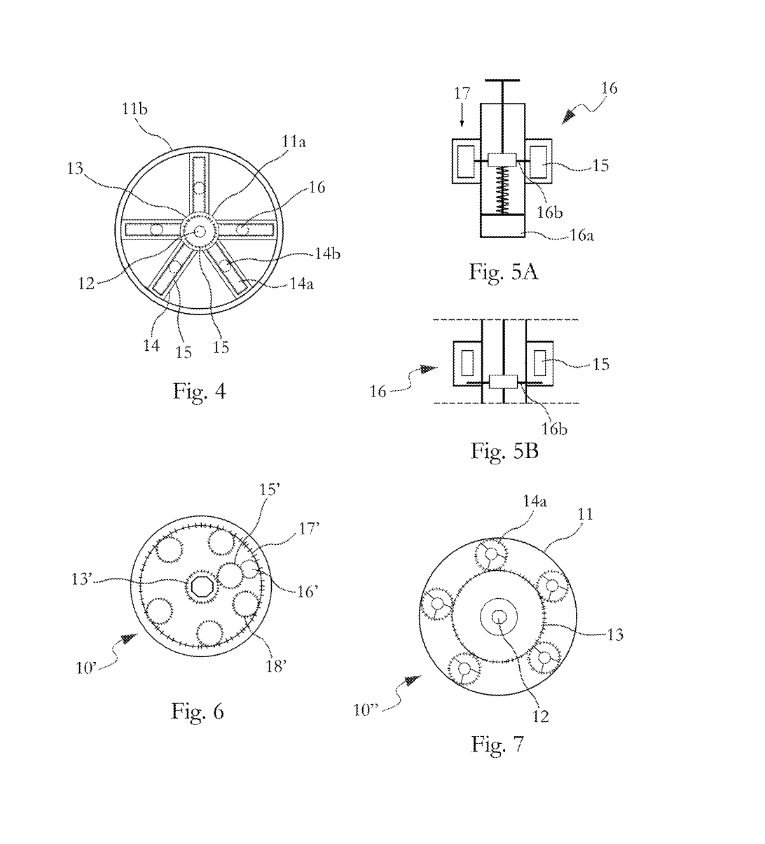

Referring now to the drawings and in particular FIGS. 1, 2, 3, 4, and 5A and 5B, a lug nut removal tool 10 is shown having a two part circular frame member 11, a drive lug 12, a drive sprocket 13, a plurality of transfer assemblies 14, and a drive chain 15. The frame member 11 defines a combined inner frame 11a and outer frame 11b which together are sized to be placed adjacent to a conventional vehicle wheel (not shown) with drive lug 12 facing away from the wheel, thereby enabling socket assemblies 16 integral with each transfer assembly 14 to be aligned with and engage the lug nuts of the vehicle wheel so as to enable each socket assembly 16 to rotate a corresponding lug nut when rotational force is applied.

The drive lug 12 is rotatably disposed in the center of the inner frame 11a and structured to engage a conventional lug wrench or other socket wrench, thereby enabling the lug nut removal tool 10 to receive manual force in a rotating direction through such a wrench. The drive lug 12 is fixedly attached to the drive sprocket 13 such that when the drive lug 12 is rotated, the drive sprocket 13 rotates.

In one embodiment, the drive lug 12 includes an integral ratchet to ease the manner in which manual force can be applied thereto

Each of the plurality of transfer assemblies 14 defines a discrete transfer member having a centralized slot 14a and a perimeter slot 14b. The transfer assemblies 14 are each slidably attached to the inner frame 11a such that they can slide around for repositioning. Slidably disposed in the centralized slot 14a is a socket assembly 16. The drive chain 15 extends into each transfer assembly 14, passing around the drive sprocket 13 in between discrete transfer assemblies 14, such that it forms a complete link that loops completely through each perimeter slot 14b and around the drive sprocket 13.

Each socket assembly 16 includes a socket component 16a for engaging a conventional lug nut and a spring loaded sprocket member 16b with a manual actuator 16c. The spring loaded sprocket member 16b, when in its operational position (illustrated in FIG. 5A) engages the drive chain 15 as it passes through the perimeter slot 14b of the socket assembly 16. Through the application of manual force on the manual actuator 16c in an actuating direction 17, the sprocket member 16b is moved down to a movable position (illustrated in FIG. 5B) defined by the sprocket member 16b positioned below the drive chain 15, no longer engaging it. In the operational position, the socket assembly 16 is locked in place in the centralized slot 14a by the drive chain 15. In the movable position, the socket assembly 16 can be repositioned in the centralized slot 14a by sliding it one way or the other.

As the drive chain 15 passes around the perimeter slot 14b of a transfer assembly 14, it engages the socket assembly 16 disposed in centralized slot 14a of that transfer assembly 14 such that when the drive chain 15 is moved by the drive sprocket 13, the socket assembly 16 is rotated. Accordingly, by rotating the drive lug 12, the drive sprocket 13 moves the drive chain 15 which in turn rotates the socket assembly 16 in each transfer assembly 14.

It is contemplated that advantageously, this embodiment of the lug nut removal tool 10 is adjustable, allowing a user to move the lug sockets to the specification of a target wheel.

Referring now to FIG. 6, in an alternate embodiment, the lug nut removal tool 10′, a single transfer assembly is additionally employed to transfer rotational force from a drive gear 13′ to the socket gears 18′. The transfer assembly in the alternate embodiment defines a first transfer gear 15′, a second transfer gear 16′, and an annular gear 17′. A socket gear 18′ is fixedly attached to each corresponding socket. In this embodiment, the rotation of the drive gear 13′ in a first direction causes the first transfer gear 15′ to rotate in a direction opposite the first direction, causing the second transfer gear 16′ and the annular gear 17′ to rotate in the first direction. The rotation of the discrete annular gear 17′ causes the rotation of the socket gear 18′, which results in the rotation of the socket connected to the particular socket gear 18′ in the first direction

Referring now to FIG. 7, a lug nut removal tool 10 in accordance with another alternate embodiment is shown having a circular frame member 11, a drive lug 12, a drive gear 13, and a plurality of sockets 14, each connected to a socket gear 14a. Each socket 14 is fixedly attached to a discrete socket gear 14a such that when the socket gear 14a is rotated, the associated socket 14 rotates. The drive gear 13 directly contacts each socket gear 14a so as to transfer rotational movement of the drive gear 13 to each respective socket 14. Through this arrangement, when the drive gear 13 is rotated, each socket gear 14a is rotated, which results in the rotation of the socket 14 connected to the particular socket gear 14a.

In various embodiments, a lug nut removal tool built in accordance with the present invention includes four sockets, five sockets, or six sockets.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A lug nut removal tool, comprising:
a frame member having a front side and a rear side;
a drive lug integral with said frame member and disposed on the front side thereof;
a plurality of sockets integral with said frame member and disposed on the rear side thereof, wherein said plurality of sockets are configured such that when the frame member is placed adjacent to a conventional vehicle wheel, the sockets aligned with and engage lug nuts on the vehicle wheel; and
said drive lug and said plurality of sockets configured such that the application of rotational force on the drive lug causes rotational force to be applied on the plurality of sockets.

2. The lug nut removal tool of claim 1, wherein said drive lug and said plurality of sockets are configured such that the application of rotational force on the drive lug causes rotational force to be applied on the plurality of sockets in the direction the force was originally applied.

3. The lug nut removal tool of claim 1, wherein said drive lug and said plurality of sockets are configured such that the application of rotational force on the drive lug causes rotational force to be applied on the plurality of sockets in the direction opposite the direction the force was originally applied.

4. The lug nut removal tool of claim 1, additionally comprising:
a drive sprocket integral with said drive lug;
a drive chain integral with said drive sprocket; and
at least one transfer assembly connected to the frame member and integral with said drive sprocket through the drive chain, wherein said drive sprocket, drive chain, and said at least one transfer assembly are operative to configure said drive lug and said plurality of sockets such that the application of rotational force on the drive lug causes rotational force to be applied on the plurality of sockets.

5. The lug nut removal tool of claim 4, wherein each socket includes a discrete transfer assembly associated therewith.

6. The lug nut removal tool of claim 5, wherein each transfer assembly is moveably connected to the frame member.

7. The lug nut removal tool of claim 5, wherein each socket is moveable between an operational position and a moveable position.

8. The lug nut removal tool of claim 7, wherein each socket includes a spring loaded actuator is moveable between an operational position and a moveable position through manual actuation of the actuator.
